(19) United States
(12) Patent Application Publication
(10) Pub. No.: US 2014/0030682 A1
(43) Pub. Date: Jan. 30, 2014

(54) TRAINING DEVICE AND METHOD FOR SPAYING AND/OR SUTURING ANIMALS

(71) Applicant: William Jackson THILENIUS, Long Beach, CA (US)

(72) Inventor: William Jackson THILENIUS, Long Beach, CA (US)

(21) Appl. No.: 13/952,093

(22) Filed: Jul. 26, 2013

Related U.S. Application Data
(60) Provisional application No. 61/675,876, filed on Jul. 26, 2012.

(51) Int. Cl. G09B 23/30

(52) U.S. Cl. CPC G09B 23/30
USPC 434/219

(57) ABSTRACT

A body defining a cavity, a model of a female reproductive organ held in the cavity, and a model of a sheet of skin that covers the body cavity. The reproductive-organ model includes a Y-shaped element with all three legs detachably coupled to the body. And the skin model is at least partially detachable from the body. In one aspect, the skin model includes a liner mounted adjacent the inner surface of the skin and adapted for realistic grasping, tenting, incising, and suturing of the liner. In other aspects, the skin model includes two layers of contrasting colors for ease of distinguishing them and/or is made of a material mimicking the feel and response of the abdominal skin of an actual animal when suturing the skin. In other aspects, the reproductive-organ model is excluded for use in only practicing suturing and/or tying ligature bands but not spaying.

### CROSS-REFERENCE TO RELATED APPLICATION

This application claims the priority benefit of U.S. Provisional Patent Application Ser. No. 61/675,876, filed Jul. 26, 2012, which is hereby incorporated herein by reference.

### TECHNICAL FIELD

The present invention relates generally to veterinary surgery involving spaying and/or suturing, and particularly to training devices and methods for such veterinary surgery.

### BACKGROUND

Spaying is a term referring to either an ovariectomy, a surgical procedure in which the ovaries of a female animal are removed to prevent reproduction; or an ovariohysterectomy, a surgical procedure in which the ovaries and the uterus of a female animal are removed to prevent reproduction. These common procedures are typically performed by veterinarians. To train such medical professionals to perform these procedures there are few options. Known training devices are limited to inexpensive but non-realistic units with a foam, gel, or fabric skin, and realistic but extremely expensive manikins.

Accordingly, it can be seen that there exists a need for a realistic and affordable device for training medical professionals to perform spaying procedures. It is to the provision of solutions to this and other problems that the present invention is primarily directed.

### SUMMARY

Generally described, the present invention relates to a training device for spaying and/or suturing animals. In a typical embodiment, the training device includes a body defining a cavity, a model of a female reproductive organ held in the cavity, and a model of a sheet of skin that covers the body cavity. The reproductive-organ model includes a Y-shaped element with all three legs detachably coupled to the body. And the skin model is at least partially detachable from the body.

In one aspect, the skin model includes a liner mounted adjacent the inner surface of the skin and adapted for realistic grasping, tenting, incising, and suturing of the liner. In other aspects, the skin model includes two layers of contrasting colors for ease of distinguishing them and/or is made of a material mimicking the feel and response of the abdominal skin of an actual animal when suturing the skin. In other aspects, the reproductive-organ model is excluded for use in only practicing suturing and/or tying ligature bands but not spaying.

In another expect, the invention relates to a method of training for spaying and suturing animals. For example, the method can include grasping, tenting, and incising a model liner initially of a training device, the liner positioned adjacent and under a skin model of the training device, in order to form a liner slit. The method can then include individually and sequentially positioning model suspensory ligament legs and a model uterus leg of a Y-shaped element of a model reproductive organ of the training device to outside of a body cavity of the training device and tying them with ligature techniques, then severing them longitudinally-outward of model ovaries. The method can then include severing or tearing a model broad ligament sheet of the model reproductive organ. The method can then include removing the severed portion of the model reproductive organ including the model ovaries. And then the method can include suturing the model liner and skin slits closed, including first suturing an inner skin layer and then suturing an outer skin layer.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is an exploded perspective view of a spaying/suturing training device according to a first example embodiment of the present invention, showing a body, a skin model, and a reproductive-organ model.

FIG. 2 is a plan view of the body of the spaying/suturing training device of FIG. 1.

FIG. 3 is a bottom view of the body of FIG. 2.

FIG. 4 is an end view of the body of FIG. 2.

FIG. 5 is a cross-sectional view of the body taken at line 5-5 of FIG. 4.

FIG. 6 is a front view of the body of FIG. 2.

FIG. 7 is a cross-sectional view of the body taken at line 7-7 of FIG. 6.

FIG. 8 is a perspective view of the body of FIG. 1 with its attached components removed.

FIG. 9 is a front view of the body of FIG. 1.

FIG. 10 is a right end view of the body of FIG. 9.

FIG. 11 is a left end view of the body of FIG. 9.

FIG. 12 is a longitudinal cross-sectional view of the body of FIG. 9.

FIG. 13 is a plan view of the reproductive-organ model of the spaying/suturing training device of FIG. 1.

FIG. 14 is a side view of the reproductive-organ model of FIG. 13.

FIGS. 15 and 15A show the reproductive-organ model of FIG. 13.

FIG. 16 is a perspective bottom view of the skin model of FIG. 1.

FIG. 17 is a partially exploded view of the skin model of FIG. 16.

FIG. 17A is a plan view of the skin model of FIG. 17 with the liner removed.

FIGS. 18-29 are various self-explanatory views of the spaying/suturing training device of FIGS. 1-17A shown in an example method of use.

### DESCRIPTION OF EXAMPLE EMBODIMENTS

The present invention relates to training devices and methods for spaying and/or suturing animals for training purposes such as for use by students/trainees (also referred to herein as “practitioners”) at veterinary schools. In typical embodiments such as those described herein, the training device is designed to simulate spaying a dog or cat. In other embodiments, the training device is adapted to simulate spaying larger or smaller mammals including but not limited to rabbits, chinchillas, prairie dogs, ferrets, guinea pigs, swine, sheep, goats, and certain reptiles. In typical embodiments such as those described herein, the training device is designed to simulate spaying a female mammal. In other embodiments, the training device is adapted to simulate neutering male mammals. Persons of ordinary skill in the art will readily understand how to adapt the training devices for differences in the size, shape, and orientation of male or female reproductive organs of larger or smaller mammals or other animals. It should be noted that the materials and dimensions specified herein are representative for illustration purposes only and thus are not limiting of the invention; the invention can be implemented using many other materials, dimensions, and shapes.

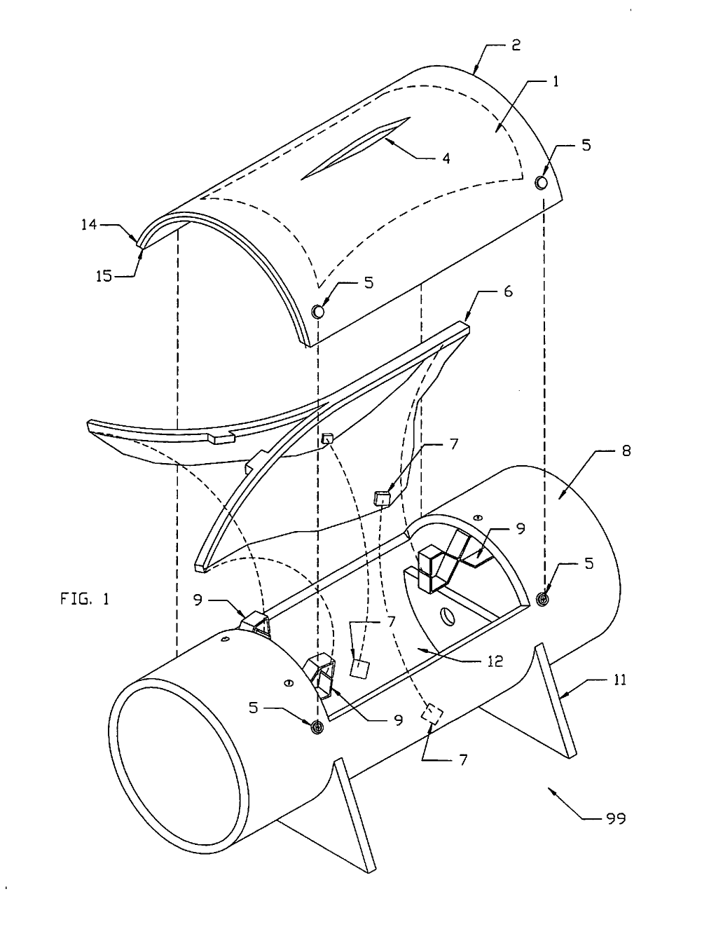

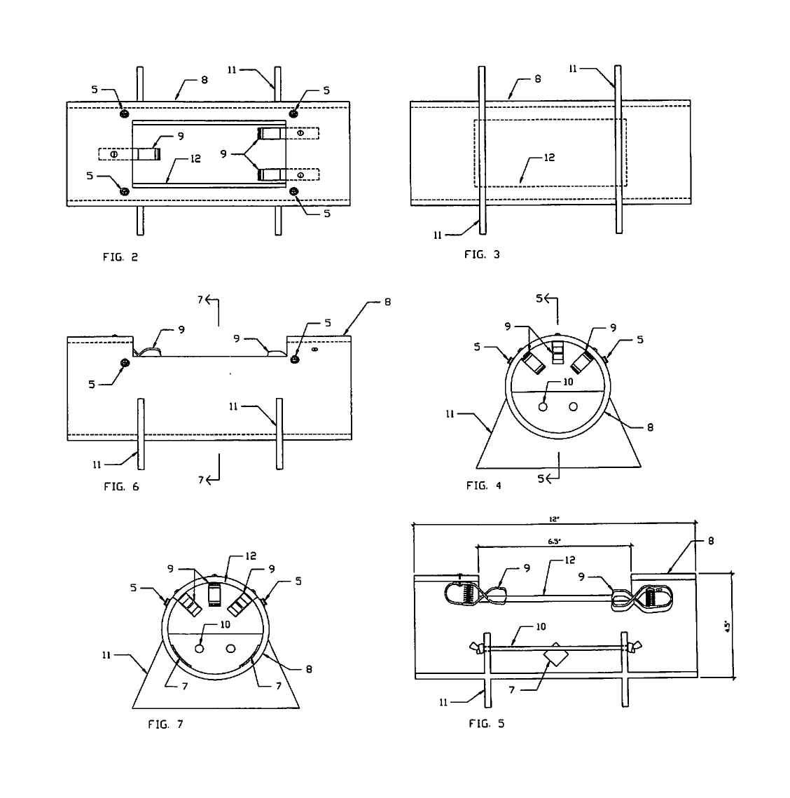

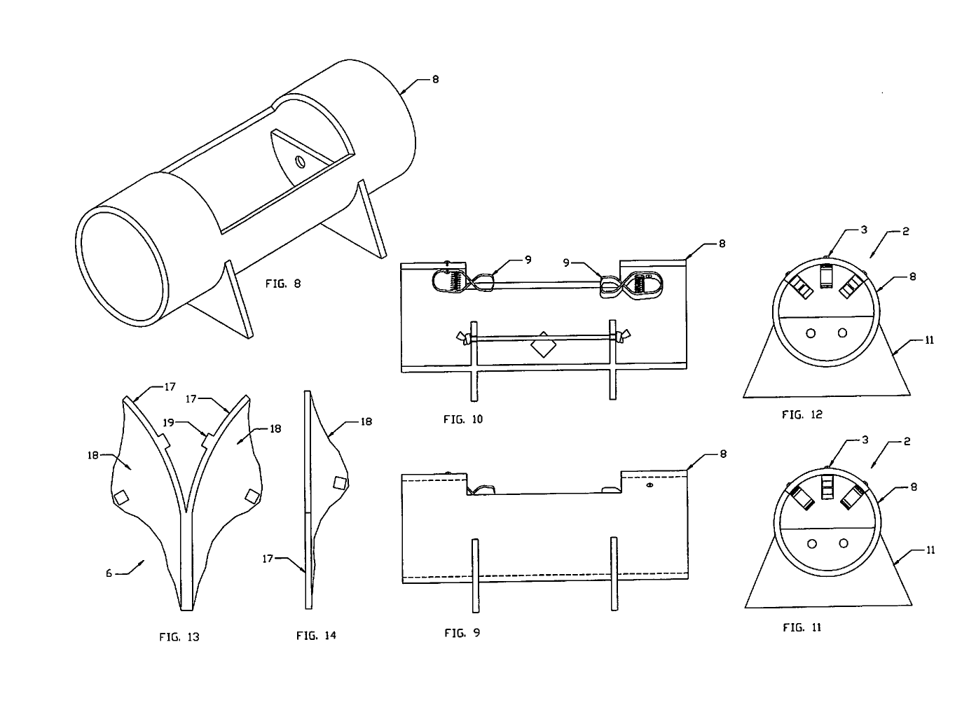

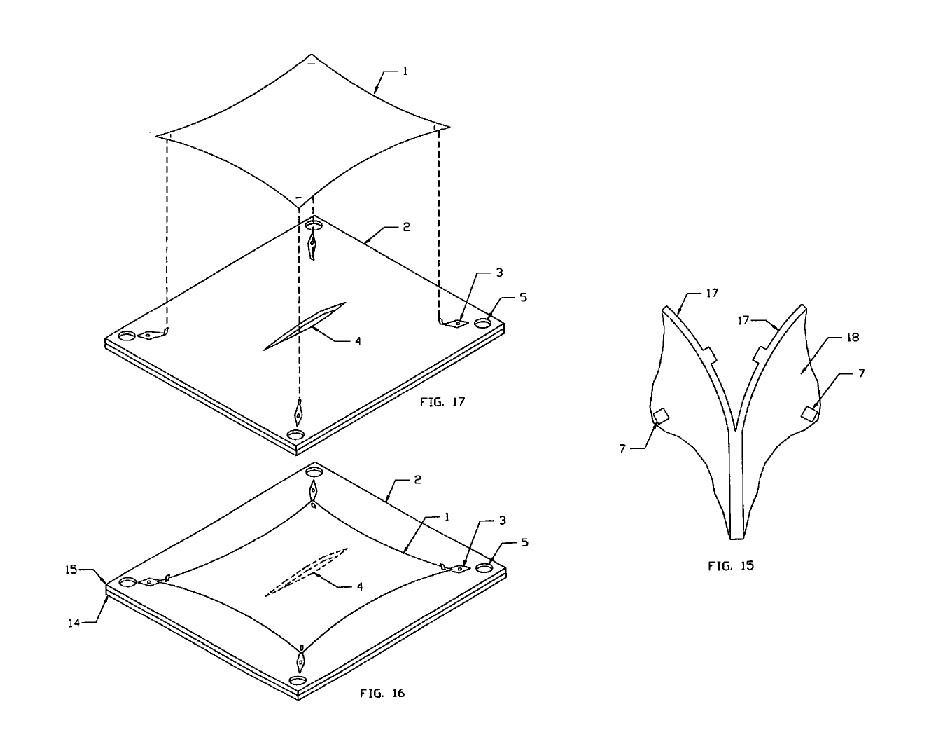

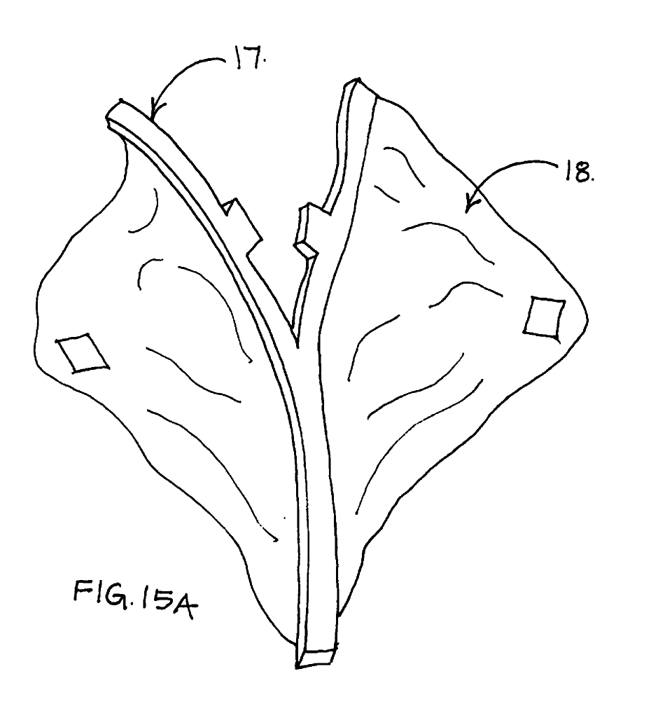

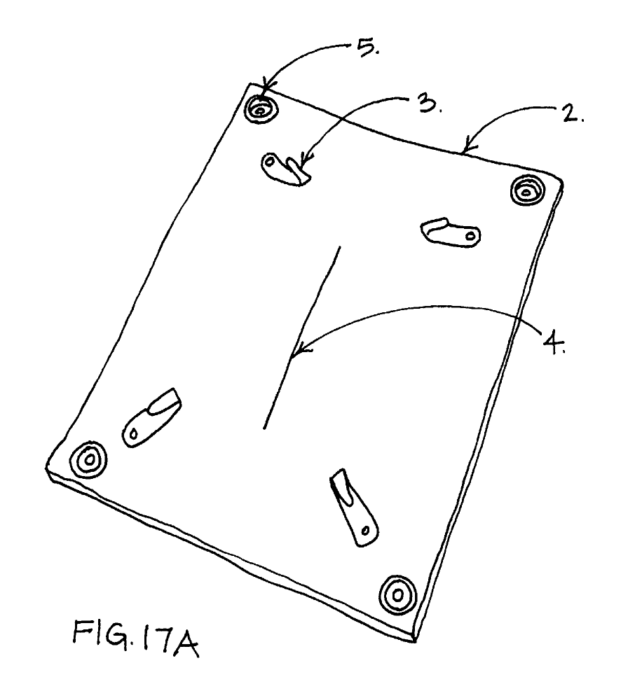

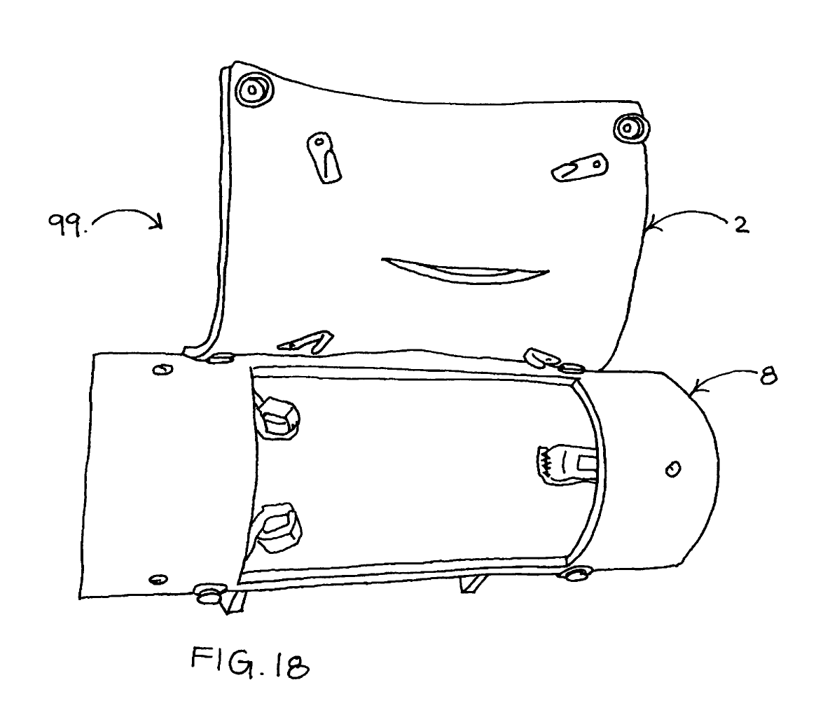

Turning now to the drawings, FIGS. 1-29 show a training device 99 for spaying and suturing animals according to a first example embodiment of the invention. The training device 99 includes a body 8, a model of a female reproductive organ 6, and a model of a sheet of skin 2. The reproductive organ 6 is held in the body 8 and the skin 2 covers it, as described in detail below.

Referring particularly to FIGS. 1-17, the body 8 includes a recessed opening or cavity 12 that holds the model reproductive organ 6. As such, the body 8 can be provided by a hollow tube of a plastic material (e.g., a 14-inch length of 4-inch diameter ABS pipe) with the opening 12 defined through its circumferential wall, as depicted. In this way, the outer surface of the body 8 adjacent the opening 12 is curved to simulate the curved abdominal area of the animal where the procedure is to be performed.

In addition, in embodiments such as this in which the body 8 does not have a flat bottom, one or more base stands 11 with flat bottoms can be provided for stability. The base stands 11 can be attached to the body 8 by epoxy or another conventional attachment. The base stands 11 can be in the form of trapezoidal sheets of a plastic material (e.g., a ¼-inch ABS flat stock) that extend into the cavity for strength, with a semi-circular portion within the body 8, as depicted. In other embodiments, the body has another regular or irregular shape but still has at least one curved outer surface portion. Persons of ordinary skill in the art will understand that the body can be made of other materials (wood, ceramic, metal, etc.) and in other configurations (including whether hollow or solid with a cavity), shapes (spheres, ellipsoids, rectilinear blocks, models of animals, etc.), and sizes, so long as it forms the cavity 12 that holds the reproductive organ 6.

The model skin 2 is provided by a sheet of material that covers the opening 12 of the body 8. The skin 2 detachably couples to the body 8 by a plurality of fasteners 5. That is, the fasteners 5 permit the skin 2 to be at least partially detached from the body (so that it forms a flap) and folded over in order to access the opening 12 and replace the reproductive organ 6 and the liner 1 (discussed below); the skin need not be entirely removable from the body. In the depicted embodiment, for example, the skin fasteners 5 are provided by four conventional snaps, with mating snap components on the skin 2 and the body 8. In other embodiments, the skin fasteners are provided by the same or another number of hooks, clips, clamps, hook-and-loop fasteners, zippers, buttons, or other conventional detachable couplings. The skin 2 is typically rectangular, though it can be provided in another regular or irregular shape. In typical embodiments such as that depicted, the skin 2 defines a pre-formed slit 4. In other embodiments, the skin 2 is provided without the slit, and the practitioner forms the slit as a step in the training procedure.

The model skin (aka abdominal wall) 2 is designed to simulate the actual skin and subcutaneous layers of the animal when suturing the slit 4, that is, to have similar elasticity and strength such that suturing the model skin has a similar feel and response as suturing actual animal skin. As such, the skin 2 is typically made of three layers: an outer double layer 14 (skin) and an inner single layer 15 (subcutaneous layer). In typical embodiments such as that depicted, the outer layer 14 is provided by a sheet (or two sheets adhered together) of spandex and the inner layer 15 is provided by a sheet of felt that are attached together by an epoxy, stitching, and/or other attachment technique. In other embodiments, the outer layer 14 (skin) is provided by another material selected for its elasticity and the inner layer 15 (subcutaneous layer) is provided by another material selected for its rigidity so that together the layers cooperate to provide the desired elasticity, rigidity, and strength to simulate actual animal abdominal skin when suturing the slit 4, including but not limited to vinyl, leather, resins, cloth, plastic mesh, sponge, gauze, foam rubber, and sheet rubber. In other embodiments, the skin has only one or two layers, or more than three layers to simulate actual animal abdominal skin when suturing the slit.

In additional, the outer and inner layer 14 and 15 design enables training of suturing the outer double layer (representing the actual epidermis and dermis of the animal's skin) and the inner layer (representing the actual hypodermis/subcutaneous fatty layer of the animal's skin) separately from each other, an important skill that can be taught using the device 99. That is, the portion of the slit 4 defined by the inner layer 15 can be carefully sutured closed using subcuticular suturing techniques and then the portion of the slit defined by the outer layer 14 can be carefully sutured closed using buried sutures. In addition, to practice the buried suturing of the outer layer 14, the two layers or plies of the outer layer 14 typically have contrasting colors (e.g., bright green and black) for ease of identifying the layers from each other. In this way, practitioners can see where the needle goes in and comes out so that they can practice buried suturing of the innermost layer of the outer layer 14 and avoid the needle penetrating the very thin outermost layer.

Furthermore, adjacent the skin 2 is a model liner sheet 1 that simulates the actual linea alba of the animal when grasping, tenting, incising, and suturing a slit 16 (see FIG. 24) in the liner. That is, the liner 1 has a similar elasticity and strength such that grasping, tenting, incising, and suturing the liner has a similar feel and response as the actual linea alba. The liner 1 is very thin relative to the skin 2. In typical embodiments such as that depicted, the liner 1 is provided by a thin sheet of latex. In other embodiments, the liner is provided by another material selected for its elasticity and strength so that it simulates the feel and response of grasping, tenting, and incising, and suturing the incised slit in, actual animal abdominal skin, including but not limited to vinyl, leather, cloth, plastic mesh, sponge, gauze, rubber balloons, and sheet rubber.

The model liner 1 is removably mounted adjacent to the inner surface of the inner layer 15 so that it can be pulled through the slit 4, grasped, tented, and incised to form the liner slit 16 through which the reproductive organ 6 can be accessed. As such, the liner 1 is typically mounted to the inner layer 15, though it can alternatively be mounted to the body 8. In typical embodiments, the liner 1 is detachably coupled to the inner layer 15 by a plurality of fasteners 3. In the depicted embodiment, for example, the liner fasteners 3 are provided by conventional hooks attached to the inner layer 15, the hooks configured for puncturing an opening (or slipping through a pre-formed opening) in the liner 1 and retaining the liner in a slightly tensioned state. In other embodiments, the liner fasteners are provided by clips, clamps, hook-and-loop fasteners (e.g., VELCRO fasteners), or other conventional detachable couplings. As such, the liner 1 is a replaceable component that is changed out for each training session.

The model reproductive organ 6 includes a Y-shaped element 17 and two sheets of a relatively thin and flexible material 18 extending outward from each elongate side of the Y-shaped element. The Y-shaped element 17 has a shape and size, and is made of a material, selected to mimic the feel and response of cutting the uterine horn of an animal's female reproductive organ, with the upper legs of the “Y” corresponding to the suspensory ligament, and the lower leg of the “Y” corresponding to the uterus. As such, the Y-shaped element 17 can be made of a foam rubber material or another material that when cut with a surgical implement mimics the feel and response of resecting an actual uterine horn of the animal, including but not limited to rubber tubing, foam tubing, and sponge. And the Y-shaped element 17 typically has a length selected such that when mounted in the body 8 it is under slight compression so that its upper legs bow outward slightly for proper externalization of the organ's legs.

With respect to the sheets 18, they have a shape and size, and are made of a material, selected to mimic the feel and response of cutting or tearing the broad ligament of an animal's female reproductive organ. As such, the broad ligament sheets 18 can be made of a cellophane material or another material that when cut with a surgical implement or torn by hand mimics the feel and response of resecting an actual broad ligament of the animal. And the sheets 18 typically have a size selected such that, when the reproductive organ 6 is mounted in the cavity 12, they extend to the body 8 for mounting to it under slight tension. In addition, in some embodiments such as that depicted, the reproductive organ 6 includes two model ovaries 19, each one attached to a respective one of the suspensory ligament legs of the Y-shaped element 17, to more realistically simulate the spaying procedure performed on the actual female reproductive organ of the animal.

The model reproductive organ 6 is positionable within the body cavity 12 and detachably coupled to the body 8 to hold it in place during the training session. The two upper legs of the Y-shaped uterine horn element 17 are detachably coupled to the body at one end of the cavity 12 and the one lower leg of the Y-shaped element is detachably coupled to the body at the opposite end of the cavity. For example, the Y-shaped element 17 can be secured to the body 8 by three fasteners 9 such as quick-release spring-biased clamps (as depicted) or other conventional detachable couplings (e.g., clips, hooks, snaps, or hook-and-loop fasteners). In some embodiments, a single fastener is provided for securing both of the upper legs of the Y-shaped element 17. In addition, the two broad ligament sheets 18 can be secured to the body 8 by two or more fasteners 7 such as hook-and-loop fastener pads (as depicted) or other conventional detachable couplings (e.g., clips, hooks, snaps, or spring-biased clamps). In other embodiments, the reproductive organ (or portions thereof) is detachably coupled to the skin 2 to hold it in place within the body cavity 12 during the training session.

The model reproductive organ 6 is a replaceable component that is changed out for each training session. In the depicted embodiment, the reproductive organ 6 and the liner 1 are changed out individually for each training session. In other embodiments, the reproductive organ 6 and the liner 1, with or without the skin 2, are combined into an integral unit such that these components can be changed out together in a single step.

In addition, in some embodiments such as that depicted, the training device includes one or more ligation bands 10 for practicing ligature (see FIGS. 5 and 10). For example, the bands 10 can be mounted to and extend between the stands 11 and can be made of a resilient material (e.g., ⅜-inch latex tubing) or another material suitable for practicing ligature. The bands 10 are typically located within the cavity 12. In this way, the ligature practice is more realistic, because the practitioners have limited sight and hand mobility while tying within the confines of the cavity 12.

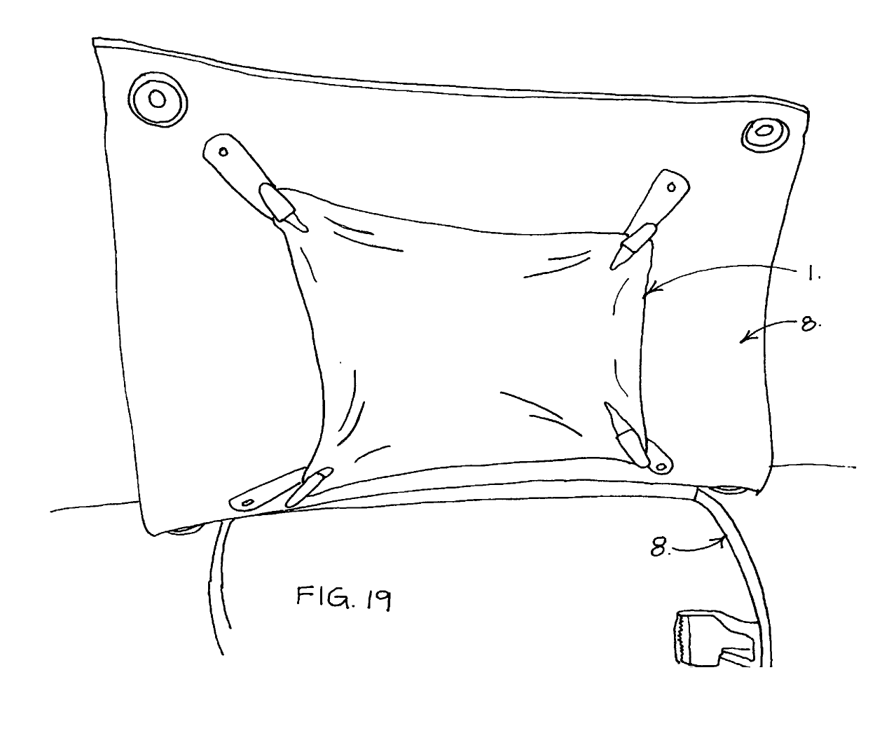

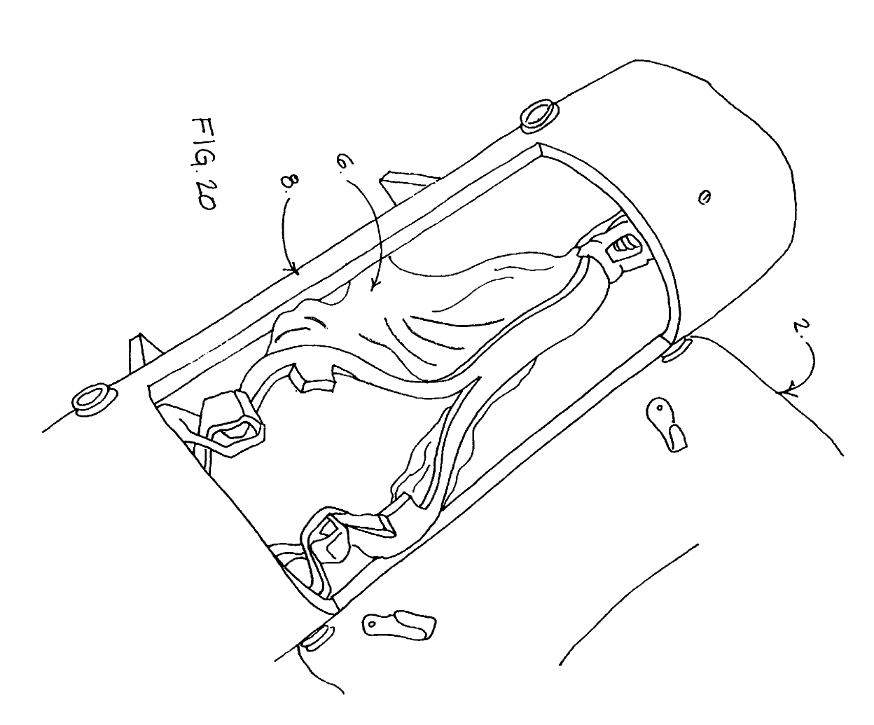

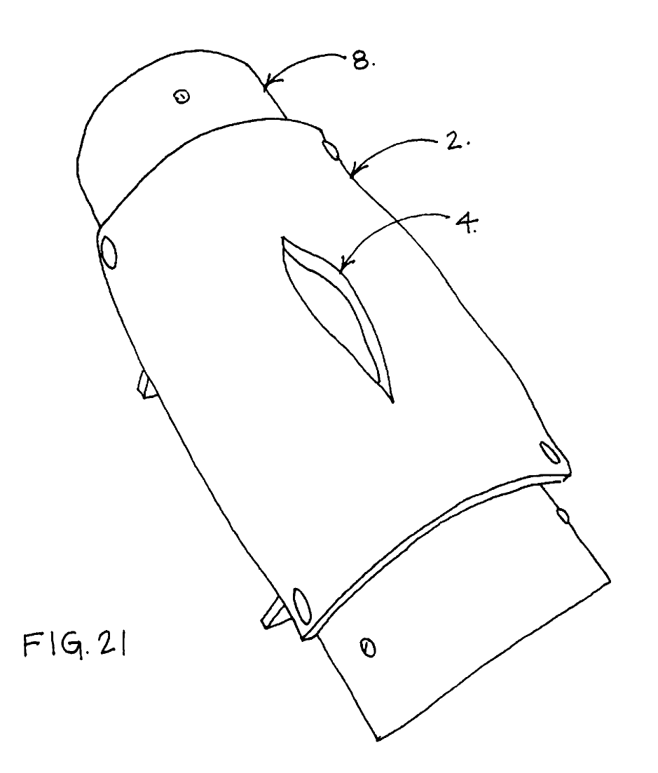

Referring particularly to FIGS. 18-29, an example method of training for spaying and suturing animals using the training device 99 will now be described. First the skin 2 is partially detached from the body 8 to expose the cavity 12 (see FIG. 18), and then the liner 1 is mounted onto the skin (see FIG. 19) and the reproductive organ 6 is mounted within the cavity (see FIG. 20) in any order. Then the skin 2 is folded back over to cover the cavity 12 and secured in place to the body 8 (see FIG. 21). Alternatively, the training device 99 can be provided with the liner 1 and the reproductive organ pre-loaded into place. The training device 99 is now ready for use.

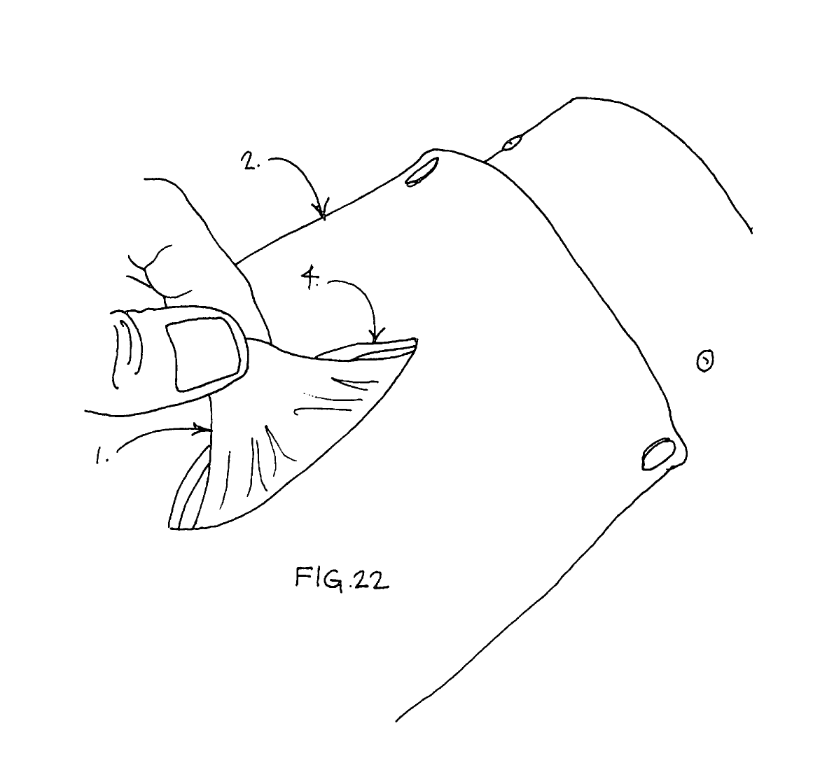

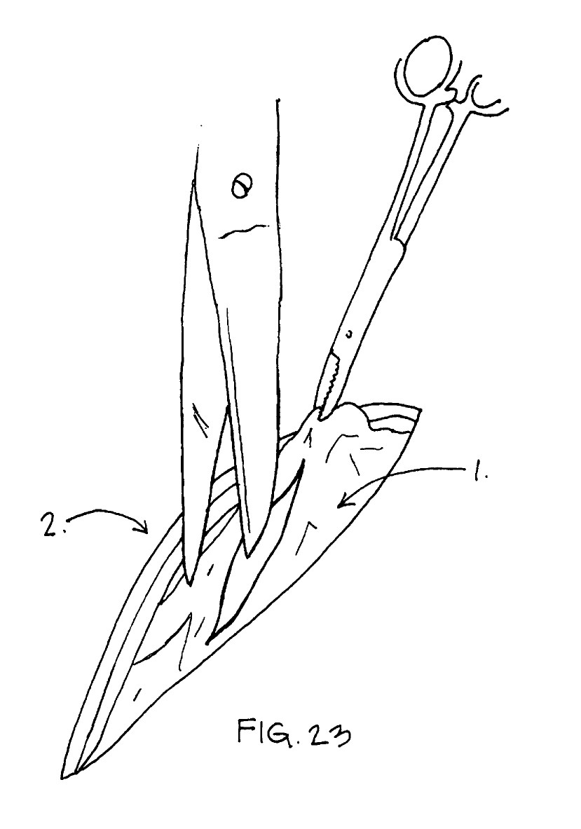

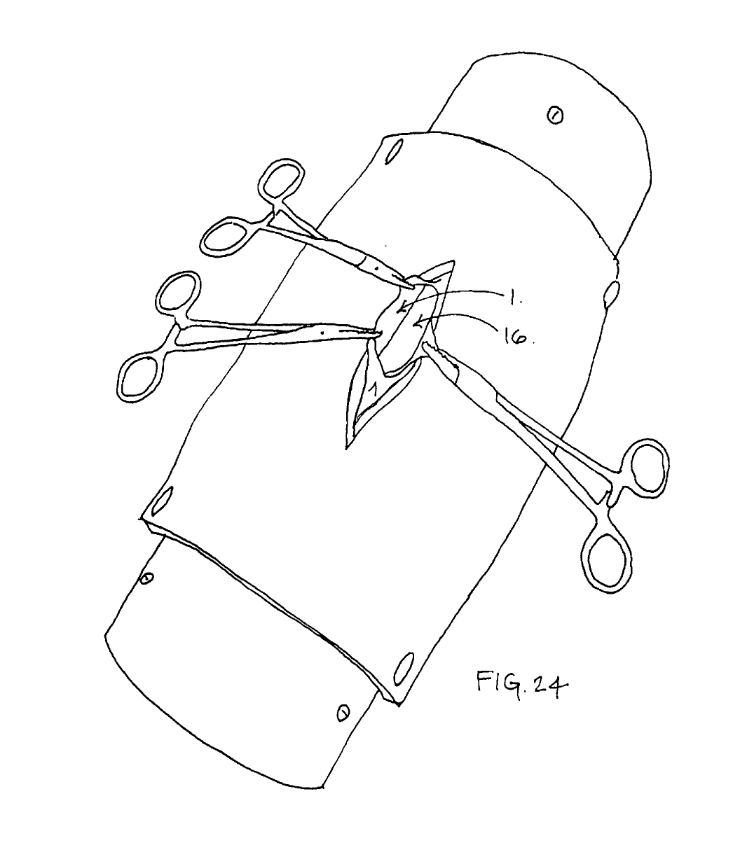

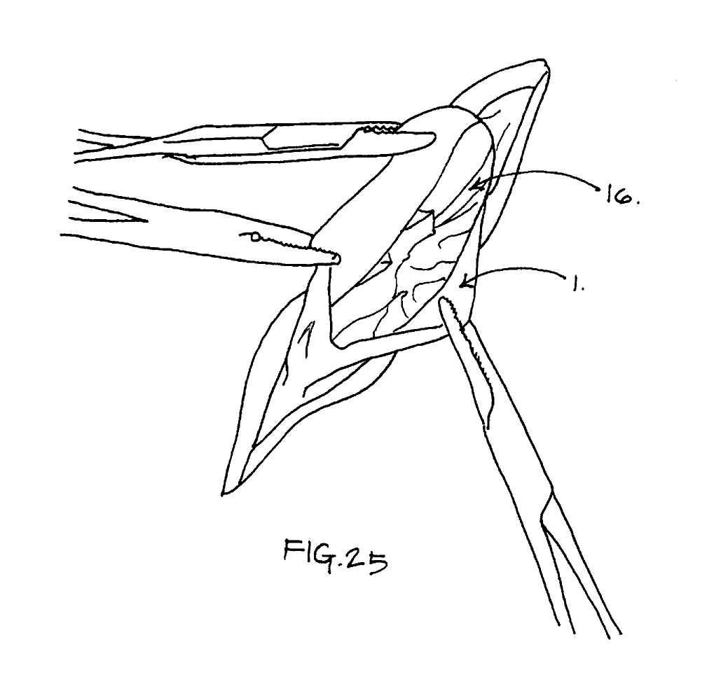

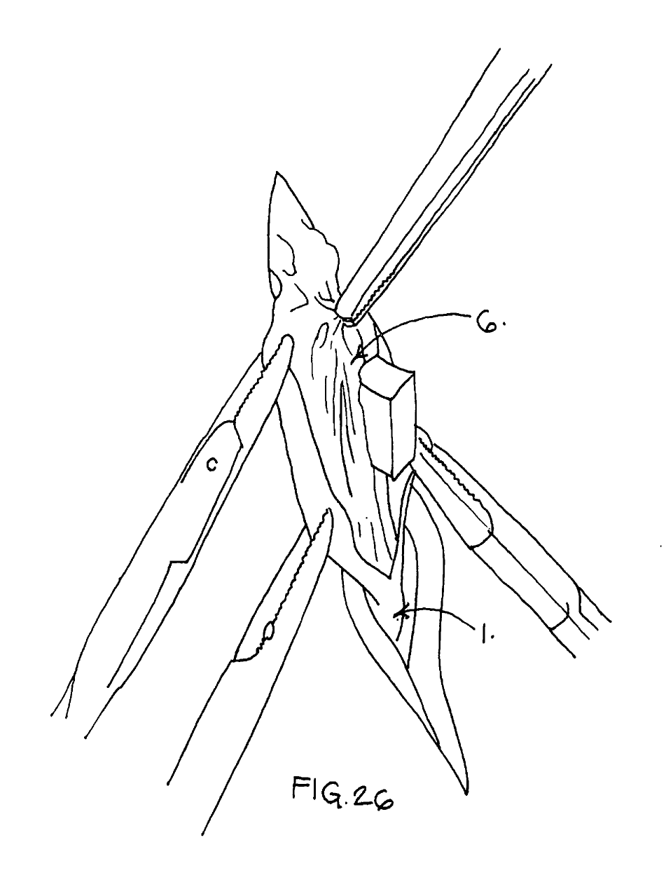

Next, the practitioner inserts a forceps or other surgical gripping tool into the slit 4, grasps the liner 1, and pulls a portion of the liner through the slit to the exterior of the body 8 in a “tenting” technique (see FIG. 22). With the liner so tented, the practitioner can then use a scalpel or other surgical incising tool to puncture the liner 1 and incise it to form the liner slit 16 (see FIG. 23). Because the liner 1 has been tented to outside of the body, this incision can be made without the risk of cutting the internal organs of the animal. Then three (or another number of) forceps can be clamped onto the slit edges of the liner 1 and left there in suspension to hold open the liner slit 16 (see FIG. 24). With the liner 1 now incised and the liner slit 16 held open, the animal's female reproductive organ can now be accessed and operated on through the liner slit (see FIG. 25).

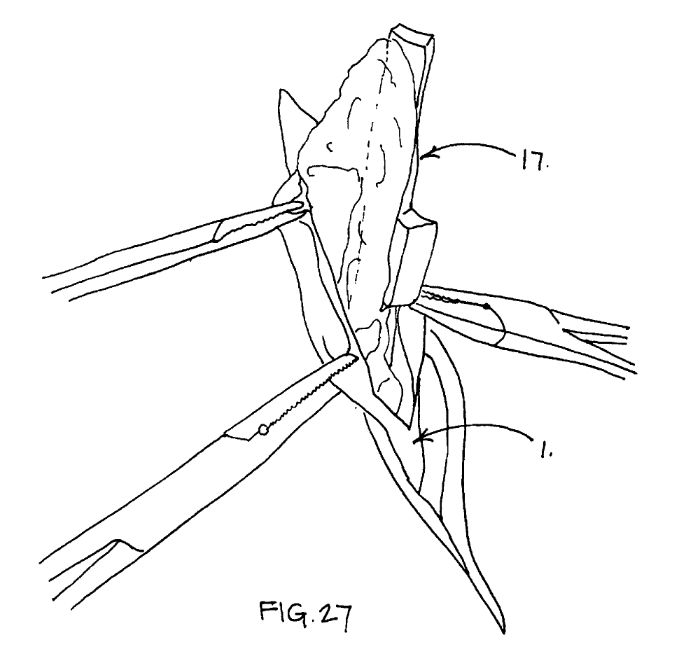

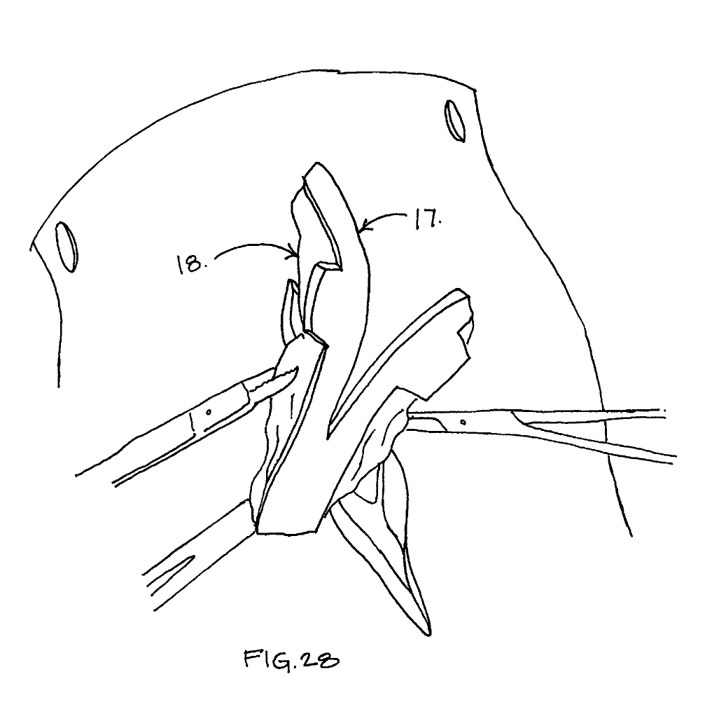

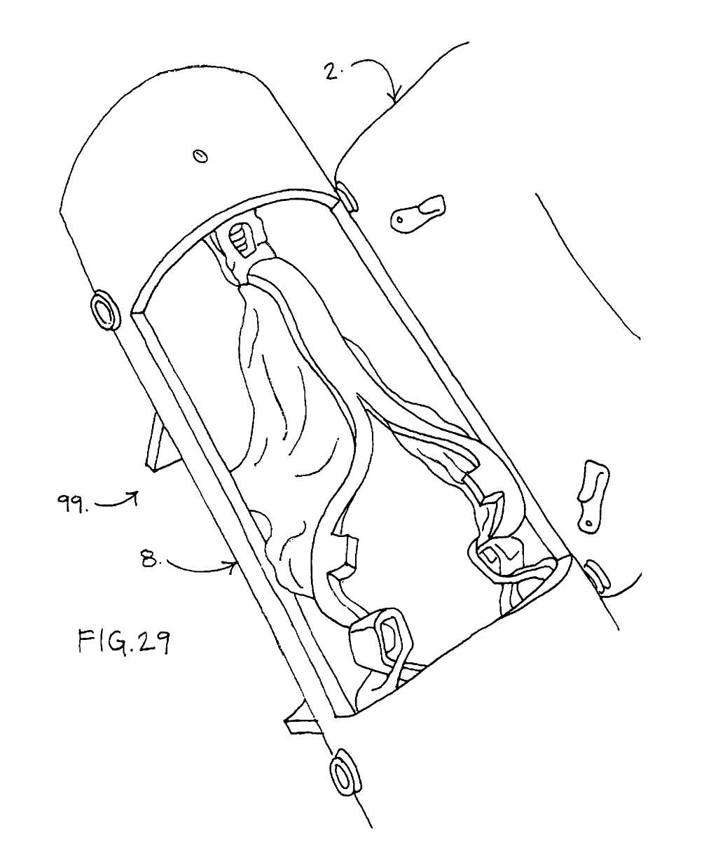

Then the practitioner inserts an ovarian hook or other surgical tool into the skin and liner slits 4 and 16 to individually and sequentially engage and pull out each of the three suspensory ligament legs of the Y-shaped element 17 (see FIG. 26). Once one of the horns/legs is externalized, the practitioner starts the process of ligature. Preferably, the Y-shaped element is made of a material that is sponge-like so that it resists the process of tying off during ligature. The practitioner makes two ligations at each peripheral portions of leg sequentially, and all cuts to follow occur between the ties isolating the portion of the Y-shaped element to be removed. The practitioner uses a scalpel or other surgical tool to cut the legs at locations outward of the model ovaries 19 (see FIG. 27). Before or after than, the practitioner cuts or tears the broad ligament sheets 18 along their entire length between the severed ends of the suspensory ligament legs of the Y-shaped element 17. At this point, a removable portion of the female reproductive organ 6 (including the ovaries 19) has been severed from the body 8 and is then pulled out of the body through the skin and liner slits 4 and 16 (see FIG. 28). Then the skin and liner slits 4 and 16 are sutured using conventional suturing techniques to complete the simulated spaying training session.

At the conclusion of the training session, or at the start of the next one, the training device 99 can be reset for use in the next training session. To do this, the skin 2 is at least partially removed from the body 8 (see FIG. 29), the liner 1 is replaced, the remnants of the reproductive organ 6 (the peripheral portions still held by the fasteners 9 and 7) are removed, and a replacement reproductive organ is installed. Also, when using an embodiment in which the skin 2 is not replaced, such as that depicted, the sutures made in the previous training session are removed, which makes for good practice at removing sutures. Or when using an embodiment in which the skin 2, the liner 1, and the reproductive organ 6 are provided as a single replaceable integral component, the used integral component is removed and replaced by a new one. The training device 99 is now ready for additional use by repeating the steps set forth above.

Accordingly, the present invention has numerous advantages over other spaying and suturing training devices. The training devices of the present invention provide a user-friendly, educational platform designed for basic spay surgical skills development. The training devices provide users the opportunity to practice their spay surgery skills in a variety of positions on a durable, rounded tissue model. This stable platform is designed to house replaceable inserts that will be utilized during each practice session.

The pre-cut, snap-on abdominal wall/skin is designed to hold a replaceable latex liner insert used to replicate the tenting and incision of the inner abdominal wall membrane associated with traditional spay techniques. This double layered, bi-colored, detachable abdominal wall/skin provides a realistic platform for buried suture and subcuticular suturing techniques.

The female reproductive organ includes a replaceable model uterine horns insert with a Y-shaped element and connected sheets that are designed to mimic the suspensory ligament, ovaries, uterus, and broad ligament. The replaceable Y-shaped insert is placed into the body cavity and is secured in position with fasteners such as clamps and hook-and-loop fastener pads. The Y-shaped insert is of appropriate length to allow for its externalization and manipulation outside of the abdominal wall/skin, and is made of materials that closely replicate the feel and response of the actual female organ parts it is mimicking.

In addition, pre-tensioned latex tubes are located inside the body cavity. These internal tubes can be used to practice internal ligation techniques and blind hand tying.

Other embodiments are included within the scope of the invention. For example, a training device for suturing animals according to a second example embodiment of the invention (as depicted in the drawings in the related provisional, which has been incorporated herein by reference) is similar to first embodiment, with a few exceptions. For instance, this embodiment does not include the female reproductive organ and thus is for practicing suturing generally but not the complete spaying process. In addition, in this embodiment the body is rotationally mounted to a stand so that can be rotated to simulate suturing on various different body parts of an animal in various different orientations. Furthermore, the cavity can serve as a storage compartment for surgical instruments and suture accessories used during the training sessions. Though not depicted, this embodiment can include the liner sheet mounted adjacent the inner surface of the skin. In another embodiment, the training device 99 of the first embodiment is provided without the reproductive organ 6 and fasteners 9 and 7 for use as a suturing, but not spaying, training platform.

This embodiment includes a number of features providing benefits. These include at least that the ninety-degree mounting option and multi-directional incisions allow for maximum versatility in subject placement and correct hand positioning. In addition, the opened advancement flap provides a realistic platform for buried suture and subcuticular suturing. Furthermore, the simulated tubular tissue samples create a realistic tool for the development of tendon suture and transfixation ligature techniques. Moreover, the adjustable internal tension bands, which can be accessed through the advancement flap, are perfect for ligature and blind hand ties. In addition, the portable platform is perfect for simulation lab or home use. And the inner cavity doubles as a storage compartment for instruments and suture accessories.

It is to be understood that this invention is not limited to the specific devices, methods, conditions, or parameters described and/or shown herein, and that the terminology used herein is for the purpose of describing particular embodiments by way of example only. Thus, the terminology is intended to be broadly construed and is not intended to be unnecessarily limiting of the claimed invention. For example, as used in the specification including the appended claims, the singular forms “a,” “an,” and “one” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

While the invention has been shown and described in exemplary forms, it will be apparent to those skilled in the art that many modifications, additions, and deletions can be made therein without departing from the spirit and scope of the invention as defined by the following claims.

What is claimed is:

1. A training device for spaying and suturing animals, comprising:
a body defining a cavity;
a model of a female reproductive organ held in the cavity and including a Y-shaped element with all three legs of the Y-shaped element detachably coupled to the body; and
a model of a sheet of skin that covers the opening in the body and is at least partially detachable from the body.

2. The training device of claim 1, wherein the skin further comprises a liner mounted adjacent the inner surface of the skin and adapted for realistic grasping, tenting, incising, and suturing the liner.

3. The training device of claim 1, wherein the skin includes two layers of contrasting colors for ease of distinguishing the two layers.

4. The training device of claim 1, wherein the skin is made of a material selected to mimic the feel and response of the abdominal skin of an actual animal when suturing the skin.

5. The training device of claim 1, wherein the reproductive organ is excluded and the device is for practicing suturing and/or tying ligature bands, but not spaying.

6. A method of training for spaying and suturing animals using the training device of claim 1, comprising the steps of:
grasping, tenting, and incising a model liner initially positioned adjacent and under the skin to form a liner slit;
individually and sequentially positioning the model suspensory ligament legs and uterus leg of the Y-shaped element of the model reproductive organ to outside of the body cavity and tying them with ligature techniques, then severing them longitudinally-outward of model ovaries;
severing or tearing the model broad ligament sheet of the model reproductive organ;
removing the severed portion of the model reproductive organ including the model ovaries; and
suturing the model liner and skin slits closed, including first suturing an inner skin layer and then suturing an outer skin layer.
